(19) United States
(12) Patent Application Publication
(10) Pub. No.: US 2009/0129743 A1
(43) Pub. Date: May 21, 2009

(54) Digital image processing apparatus

(75) Inventor: Seok-young Joo, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/283,589

(22) Filed: Sep. 12, 2008

(30) Foreign Application Priority Data
Nov. 16, 2007 (KR) 10-2007-0117438

(51) Int. Cl. H04N 5/91

(52) U.S. Cl. 386/68

(57) ABSTRACT

Provided is a digital image processing apparatus that can provide a user with increased convenience in searching for a frame in a moving picture. The digital image processing apparatus includes: a storage medium storing moving picture files; and a display unit displaying a moving picture from the moving picture file stored in the storage medium. When a user inputs a search signal as the moving picture is being displayed on the display unit, a moving picture for searching is simultaneously displayed on the display unit while continuously displaying the moving picture on the display unit.

### CROSS-REFERENCE TO RELATED PATENT APPLICATIONS

This application claims the benefit of Korean Patent Application No. 10-2007-0117438, filed on Nov. 16, 2007, in the Korean Intellectual Property Office, the disclosure of which is incorporated herein in its entirety by reference.

### BACKGROUND OF THE INVENTION

1. Field of the Invention

The present invention relates to a digital image processing apparatus, and more particularly, to a digital image processing apparatus for providing a user with increased convenience in searching for a frame in a moving picture.

2. Description of the Related Art

In general, digital image processing apparatuses store moving picture files in a storage medium and display on a display unit a moving picture (e.g., movie) which is retrieved from the stored moving picture files in the storage medium. A digital photographing apparatus, which is one kind of a digital image processing apparatus, photographs images (e.g., still and/or moving pictures) and stores the images in a storage medium.

With regard to a conventional digital image processing apparatus, if a user inputs a search signal to search for a frame of a moving picture when the moving picture is displayed on the display unit, the display of the moving picture on the display unit is replaced with a “moving picture for searching.” The search signal may be input by a user by pressing a fast forward (FF) button or a rewind (REW) button during the display of the moving picture. The button may be pressed once or continuously. The “moving picture for searching” (hereinafter MPFS) means that the image shown on the display is the moving picture in fast forward or reverse produced or defined by skipping frames. In a case where the FF button is pushed during displaying the moving picture, the MPFS shows the moving picture in fast forward by skipping next frames. Similarly, in a case where the REW button is pushed during displaying the moving picture the MPFS shows the moving picture in a fast by skipping previous frames.

In the conventional digital image processing apparatus, if the user inputs the search signal when the moving picture is displayed on the display unit, the display of the moving picture on the display unit is stopped, and then, the MPFS is displayed on the display unit replacing the moving picture. Therefore, the user cannot view the display of the original moving picture.

### SUMMARY OF THE INVENTION

The present invention provides a digital image processing apparatus and method for providing a user with improved convenience in searching for a frame of a moving picture.

According to an aspect of the present invention, there is provided a digital image processing apparatus including: a storage medium storing moving picture files; and a display unit displaying a moving picture from the moving picture file stored in the storage medium, wherein if there is a search signal input by a user when a moving picture is displayed on the display unit, a moving picture for searching (MPFS) window is simultaneously displayed on the display unit while continuously displaying the moving picture in another window on the display unit.

The moving picture window and the MPFS window may be displayed on the display unit while the search signal is continuously input by the user. An initial frame of the MPFS is a frame of the moving picture that was displayed when the search signal is initially input by the user. Depending on a search direction defined by the search signal, either previous frames or next frames of the moving picture are displayed in the MPFS window after the initial frame. When the input of the search signal is stopped, the display unit may not display the MPFS, but instead may display a frame image of the moving picture for searching, the frame image being the one shown on the display unit when the input of the search signal is stopped.

The search signal may be a signal input only once, and the MPFS may be a moving picture starting from a frame, which corresponds to the frame image of the moving picture being displayed on the display unit when the search signal is input from the user for displaying previous frames or next frames.

If a search-stop signal is input by the user when the moving picture and the MPFS are simultaneously displayed on the display unit, the display unit may not display the MPFS, but instead may display a frame image of the MPFS, which is displayed on the display unit when the search-stop signal is input by the user, while continuously displaying the moving picture on the display unit.

If a search cancel signal is input by the user when the moving picture and the frame image of the MPFS are simultaneously displayed on the display unit (after having receiving the search-stop signal from the user), the frame image of the moving picture for searching may not be displayed on the display unit any more and instead only the moving picture may be displayed on the display unit.

If a display signal is input by the user after the search-stop signal from the user, the display unit may not display the moving picture that is displayed on the display unit and the frame image of the MPFS that is displayed on the display unit, but instead may display a moving picture from a moving picture file, the moving picture starting from a frame that corresponds to the frame image of the MPFS being displayed on the display unit.

If a search signal is input again by the user after the search-stop signal, the display unit may not display the frame image of the MPFS, which is displayed on the display unit, but may instead display again the MPFS starting from the frame image being displayed on the display unit, a previous frame of the frame image, or a next frame of the frame image, while continuously displaying the moving picture.

If a search cancel signal is input by the user when the moving picture and the MPFS are simultaneously displayed on the display unit, the moving picture for searching may not be displayed any more on the display unit, and only the moving picture may be displayed on the display unit.

If a search signal is input by the user, the display unit may be divided into a first region and a second region wherein the first region is defined by a first window displaying/showing the moving picture and the second region is defined by a second window displaying/showing the MPFS.

According to the digital image processing apparatus of the present invention, the convenience of searching for a frame in the moving picture can be improved.

### BRIEF DESCRIPTION OF THE DRAWINGS

The present invention will be described according to example embodiments thereof with reference to the attached drawings in which:

FIG. 1 is a schematic block diagram of an example digital image processing apparatus according to an embodiment of the present invention;

FIG. 2 illustrates a moving picture displayed on a display unit of the digital image processing apparatus of FIG. 1;

FIGS. 3 through 6 illustrate a moving picture and/or a MPFS being displayed on the display unit of the digital image processing apparatus of FIG. 1 for describing operations of the digital image processing apparatus of FIG. 1; and

FIG. 7 is a schematic perspective view of another example digital image processing apparatus according to another embodiment of the present invention.

### DETAILED DESCRIPTION OF THE INVENTION

Hereinafter, embodiments of the present invention will be described with reference to accompanying drawings.

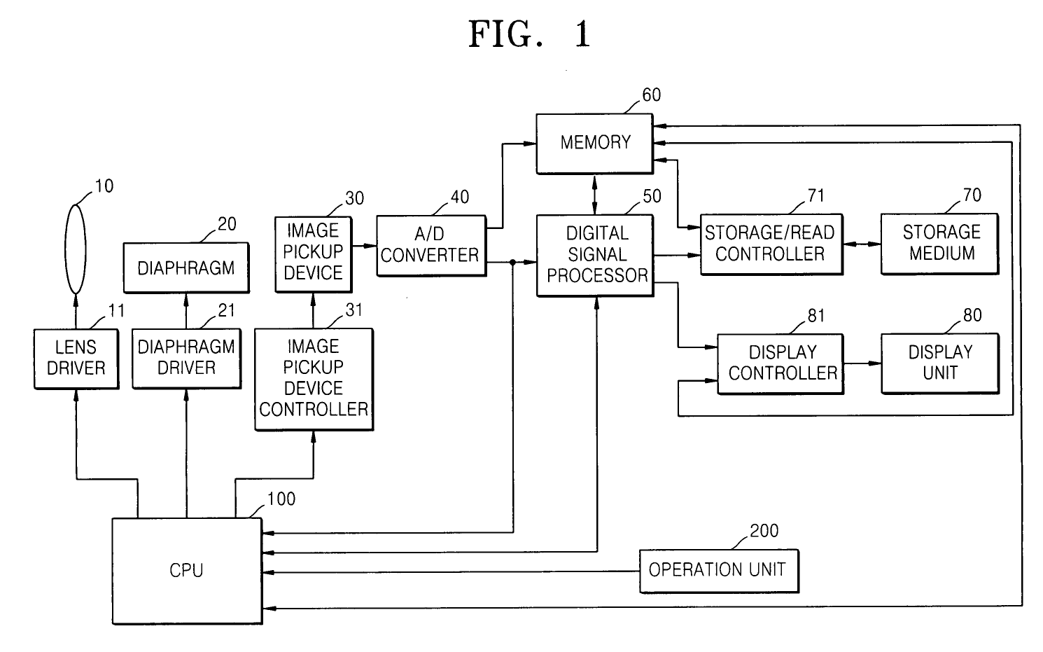

FIG. 1 is a schematic block diagram of an example digital image processing apparatus according to an embodiment of the present invention. In particular, FIG. 1 shows a digital photographing apparatus as an embodiment of the present invention.

Operations of the digital photographing apparatus are controlled by a central processing unit (CPU) 100. In addition, the digital photographing apparatus includes an operation unit 200 including buttons for generating electric signals when pressed by a user. The electric signals from the operation unit 200 are transferred to the CPU 100 so that the CPU 100 can control the digital photographing apparatus according to buttons pressed by a user.

In a photographing mode, when an electric signal concerning photograph capturing is sent to the CPU 100 from, for example a shutter-release button of the operation unit 200, the CPU 100 identifies the electric signal and controls a lens driver 11, a diaphragm driver 21, and an image pickup device controller 31. Accordingly, a position of a lens 10, an aperture of a diaphragm 20, and a sensitivity of an image pickup device 30 are adjusted. The image pickup device 30 generates data relating to still images or a moving picture from input light, and an analog/digital (A/D) converter 40 converts analog data output from the image pickup device 30 into digital data. The A/D converter 40 may not be required according to characteristics of the image pickup device 30.

The data output from the image pickup device 30 can be communicated to the digital signal processor 50 via or using a memory 60. Also, the data output from the image pickup device 30 can be communicated to the digital signal processor 50 directly, that is without passing through the memory 60. Furthermore, the data output from the image pickup device 30 can be communicated to the CPU 100 if necessary. The memory 60 may be a read only memory (ROM) or a random access memory (RAM). The digital signal processor 50 can perform a digital signal processing operation such as a gamma-compensation or a white balance adjustment.

The data of still images or the data of moving picture output from the digital signal processor 50 is transferred to a display controller 81 directly or through the memory 60. The display controller 81 controls a display unit 80 to display the still image or the moving picture on the display unit 80. In addition, the data output from the digital signal processor 50 may be input into a storage/read controller 71 through the memory 60 or directly from the image pickup device 30 and/or the A/D converter 40 so that the storage/read controller 71 stores the data in a storage medium 70 automatically or according to a signal from the user. The storage/read controller 71 reads the data from the still image file or the moving picture file stored in the storage medium 70 and inputs the data into the display controller 81 through the memory 60 and the digital signal processor 50 or through other paths so as to display the still image or the moving picture on the display unit 80. The storage medium 70 can be detached from or permanently installed in the digital photographing apparatus.

The digital photographing apparatus shown in FIG. 1 is one embodiment of the present invention, and it should be understood that the present invention is not limited thereto. That is, the present invention can be applied to personal digital assistances (PDAs), mobile phones, personal media players (PMPs), or computers that can display still image files and/or images from a moving picture file stored in the storage medium, and/or the moving picture. In addition, the digital photographing apparatus is not limited to the structure shown in FIG. 1. That is, the digital photographing apparatus will be mainly described in the current embodiment and other embodiments that will be described later, however, the present invention is not limited thereto.

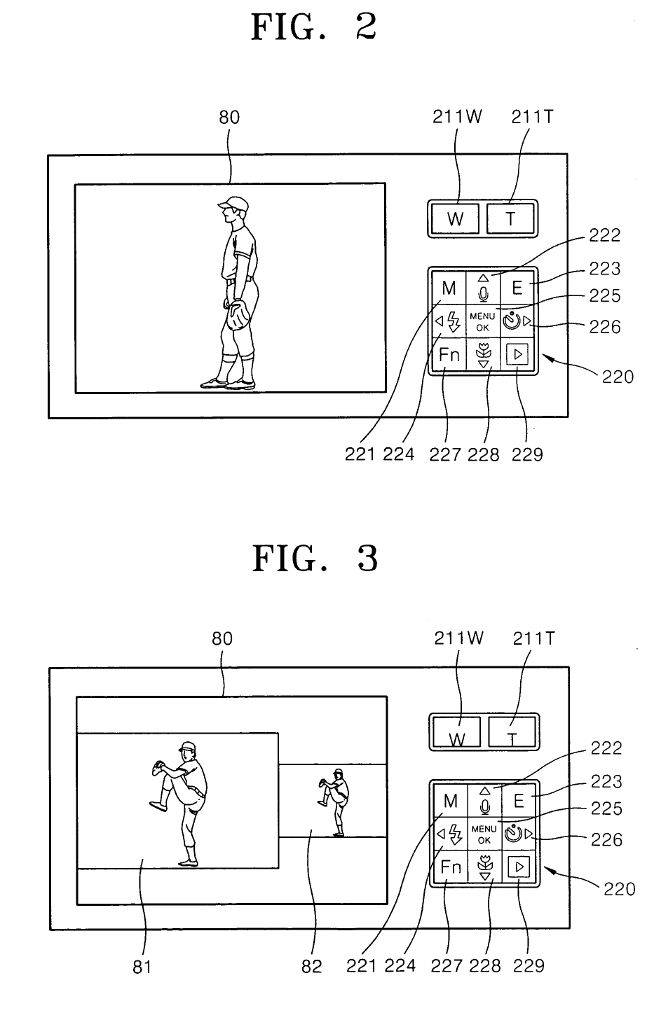

FIG. 2 illustrates a moving picture being displayed on a display unit of the digital image processing apparatus of FIG. 1. FIGS. 3 through 6 illustrate a moving picture and/or a moving picture for searching (MPFS) displayed on the display unit by the digital image processing apparatus of FIG. 1 for describing operations of searching for a frame of a moving picture stored in and displayed by the digital image processing apparatus of FIG. 1.

Referring to FIG. 2, a moving picture is displayed on the display unit 80. Buttons included in the operation unit (e.g., operation unit 200 of FIG. 1) are disposed on a right side of the display unit 80.

As shown in FIG. 2 the apparatus includes a zoom-out button 211W, a zoom-in button 211T, a still image/moving picture conversion button 221, a display unit on/off button 222, a special effect button 223, a flash control button 224, a menu/ok button 225, a timer button 226, a function button 227, a photographing mode selection button 228, and a play button 229. The display unit on/off button 222, the photographing mode selection button 228, the flash control button 224, and the timer button 226 can perform functions of moving a cursor on the display unit 80 (e.g., on a menu screen) in a direction (e.g., up, down, left and right) as indicated by indicia on the respective buttons. The flash control button 224 and the timer button 226 can perform as a REW button and a FF button when the moving picture is displayed on the display unit 80. The menu/ok button 225 can perform as a stop button for stopping displaying of the moving picture or the MPFS. The buttons can be configured on the digital image processing apparatus in various ways. Hereinafter, the flash control button 224 and the timer button 226 will be referred to as the REW button and the FF button for convenience.

As shown in FIG. 2, the digital image processing apparatus according to the current embodiment can display the moving picture from the moving picture file stored in the storage medium on the display unit 80. The moving picture may be defined by a plurality of frame image. To this end, the moving picture is displayed on the display unit 80 (e.g., substantially the entire display area of the display unit 80 or in a window/frame generated on the display unit 80) by continuously and sequentially displaying the plurality of frame images on the display unit 80. Referring to FIG. 3, if a search signal is input by the user during displaying the moving picture from a moving picture file stored in the storage medium on the display unit 80, the digital image processing apparatus of the current embodiment displays a MPFS in a MPFS window 82 on the display unit 80 while displaying the moving picture in a moving picture window 81 on the display unit 80 continuously. By comparing FIG. 3 to FIG. 2 it can be appreciated that the moving picture may be resized to fit in the moving picture window 81, which is configured adjacent to the MPFS window 82. Alternatively, the MPFS window 82 may be overlaid or the like (e.g., similar to a picture-in-picture (PIP) window) pm the moving picture window 81, which may remain substantially unchanged in size (e.g., occupying substantially the entire display area of the display unit 80).

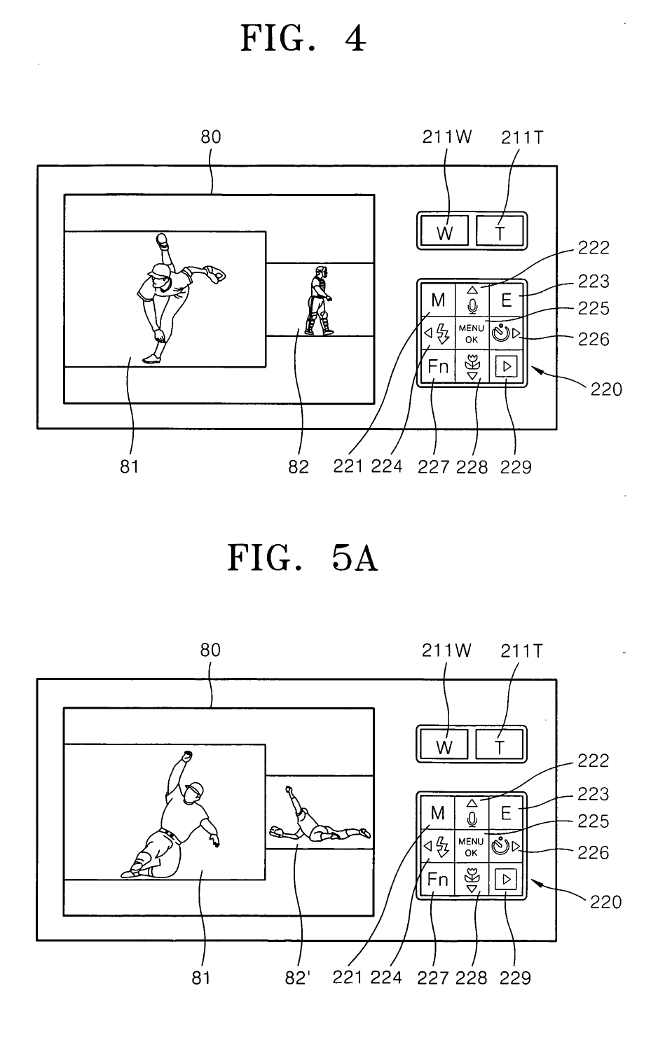

FIG. 3 shows a case where the moving picture window 81 and the MPFS window 82 start to be displayed simultaneously on the display unit 80 due to the search signal input by the user. As shown in FIG. 3, at this initial point the moving picture window 81 and the MPFS window 82 show the same image or frame. However, the moving picture window 81 and the MPFS window 82 will show different images or frames as the searching operation proceeds, for example as shown in FIG. 4. When the moving picture window 81 and the MPFS window 82 start to be displayed simultaneously on the display unit 80 in response to the search signal from the user, the MPFS window 82 may not show the frame image corresponding to the frame image of the displayed moving picture window 81, instead, the MPFS window 82 may show a previous frame image or a next frame image, unlike in FIG. 3. That is, the frame shown in the MPFS window 82 is time shifted to be earlier or later than the image or frame shown in the moving picture window 81 relative to the search signal that was input by the user. When the search signal is input by the user, the display unit 80 is configured in a first region and a second region. The first region may display the moving picture window 81 whereas the second region may display the MPFS window 82, or vice versa.

The search signal may be input by a user by pressing and releasing the FF button 226 or the REW button 224 of the digital image processing apparatus. Alternatively, the search signal may be input by a user by continuously pressing (i.e., pressing and holding) the FF button 226 or the REW button 224 when the moving picture is displayed. When the FF button 226 of the digital image processing apparatus is pushed during display of the moving picture the MPFS window 82 shows the moving picture which was displayed on the display unit 80 in fast forward, for example by skipping frames which would normally have been displayed on the display unit 80 if the FF button 226 of the digital image processing apparatus was not pushed. Similarly, when the REW button 224 is pushed during display of the moving picture the MPFS window 82 shows the moving picture which was displayed on the display unit 80 in fast reverse, for example by skipping frames which would normally have been displayed on the display unit 80 if the REW button 224 of the digital image processing apparatus was not pushed.

For example, if a moving picture has 108000 frame images and the 1001st frame image is being displayed on the display unit 80 at the time when the search signal is input by the user, the MPFS window 82 that is generated on the display unit 80 shows frames as follows when the FF signal is input: the 1001st frame image, the 1005th frame image, the 1009th frame image, the 1013th frame image, and so on. That is, the MPFS window 82 shows every fourth frame in the forward direction. If the search signal from the user is the REW signal, the MPFS window 82 is displayed on the display unit 80 while showing the frame images of the moving picture in an order of, for example, 1001st frame image, 997th frame image, 993rd frame image, 889th frame image, and so on. That is, the MPFS window 82 shows every fourth frame in the reverse direction. The present invention is not limited to the above example, and an interval of skipping over frames can be modified variously (i.e., every other frame, every third frame, etc.)

In the conventional digital image processing apparatus, if a search signal is input by a user when a moving picture is displayed on the display unit, the display of the moving picture is stopped and replaced by the MPFS. Therefore, the user cannot see the display of original moving picture. However, according to the present digital image processing apparatus and method, if a search signal is input by the user when the moving picture is displayed on the display unit 80, the MPFS can be simultaneously displayed in an MPFS window 82 on the display unit 80 while continuously displaying the moving picture in a moving picture window 81 on the display unit 80. Therefore, the user can see the display of the original moving picture in addition to the MPFS

Determining whether the user inputs the search signal can be achieved in various ways. Two examples in this regard are as follows.

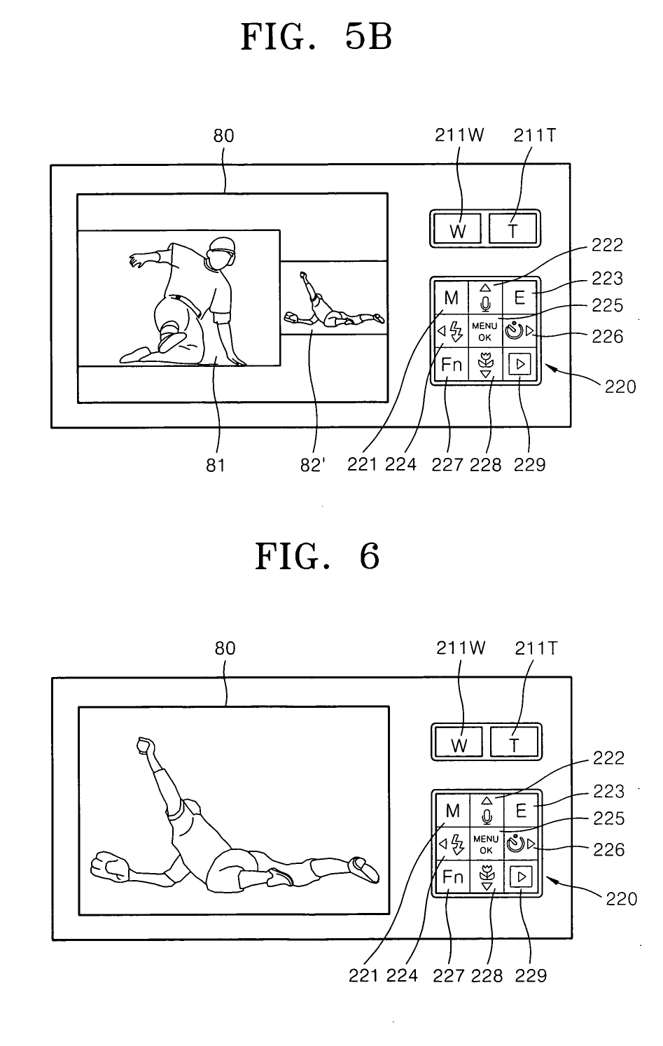

In a first example, whether the user inputs the search signal can be determined from the state of continuously pressing the FF button 226 or the REW button 224 of the digital image processing apparatus during the display of the moving picture. In this case, when the user continuously presses (i.e., presses and holds) the FF button 226 or the REW button 224, the moving picture window 81 and the MPFS window 82 are simultaneously displayed on the display unit 80 for showing the respective moving picture and MPFS as shown in FIG. 4. In addition, the initially-displayed image or frame of the MPFS can be the image or frame of the moving picture that was displayed when the search signal is initially input by the user, the previous frame of the corresponding frame, or the next frame of the corresponding frame. When the input of the search signal is stopped, that is, when the user stops continuously pressing (i.e., releases) the FF button 226 or the REW button 224, the digital image processing apparatus of the current embodiment displays in the MPFS window 82 a frame image 82′ (FIG. 5A) of the MPFS which is being displayed when the input of the search signal is stopped. Simultaneously and continuously with the displaying of the frame image 82′, the apparatus shows the moving picture in the moving picture window 81 on the display unit 80 as shown in FIGS. 5A and 5B. The instant when the FF button 226 or the REW button 224 of the digital image processing apparatus are stopped from being pressed continuously is the point when a search-stop signal is generated. When the search signal input is stopped or overridden by initiation/generation of the search-stop signal, the digital image processing apparatus of the current embodiment can display an image corresponding to the previous frame image or to the next frame image of the frame image that is displayed on the display unit 80 when the search signal is stopped. That is, as can be appreciated from comparing FIG. 5B to FIG. 5A, although the MPFS shown in the MPFS window 82 becomes frozen at a frame or image 82′ once the search-stop signal is generated, the moving picture being displayed in the moving picture window 81 continues to be played (i.e., advances).

In another example, whether the user inputs the search signal can be determined from one push (i.e., a press and release operation) of the FF button 226 or the REW button 224 of the digital image processing apparatus during the display of the moving picture. That is, the search signal input by the user is generated only once, and the moving picture for searching can be set as the moving picture starting from the frame corresponding to the frame image that is displayed when the search signal is input by the user, the previous frame, or the next frame. In this case, the search-stop signal is generated by an additional key operation from the user, unlike the above example.

As shown in FIG. 4, when the search-stop signal is input by the user when the moving picture window 81 (showing the moving picture) and the MPFS window 82 (showing the MPFS) are displayed simultaneously on the display unit 80, the digital image processing apparatus of the current embodiment stops the MPFS and displays the frame image 82′ that is displayed in the MPFS window 82 at the instant the search-stop signal is generated. Along with displaying the frame image 82′ in the MPFS window 82 on the display unit 80, the moving picture window 81 is also continuously generated on the display unit 80 for showing the moving picture as shown in FIGS. 5A and 5B. When the search-stop signal is input, the digital image processing apparatus of the current embodiment also can display the previous frame image or the next frame image of the frame image, which is displayed on the display unit 80 when the search-stop signal is input from the user.

If a display signal is input by the user after the search-stop signal, the digital image processing apparatus of the current embodiment does not display the frame image of the moving picture displayed on the display unit and the frame image 82′ of the MPFS that is displayed on the display unit, but instead displays the moving picture starting from the frame which corresponds to the frame image 82′ of the MPFS window 82 that is displayed on the display unit. That is, when the frame image 82′ is shown in the MPFS window 82 on the display unit 80 along with the moving picture window 81 and the display signal is input by the user, the display signal causes the moving picture is to be again displayed on substantially the entire display area of the display unit 80 as shown in FIG. 6 with the initially-displayed frame/image of the moving image corresponding to the frame image 82′ of FIG. 5B—the full-sized moving picture is displayed on the display unit 80 starting from the frozen image of the MPFS window 82 (i.e., frame image 82′).

For example, when the 1101st frame is the frame image 82′ shown in the MPFS window 82 while the moving picture window 81 is continuously showing the moving picture, if the display signal is input by the user the moving picture window 81 and the MPFS window 82 are replaced with a full-sized moving picture starting from the 1101st frame, which corresponds to the frame image 82′ of FIG. 5B. Alternatively, the full-sized moving picture can be displayed on the display unit 80 from the previous frame or the next frame of the frame, which corresponds to the frame image 82′ of the moving picture for searching displayed on the display unit 80. Thus, various modifications are possible.

On the other hand, as shown in FIGS. 5A and 5B, if the user inputs again the search signal when the frame image 82′ of the MPFS is displayed on the display unit 80 in response to the search-stop signal, the MPFS can be displayed again (i.e., the MPFS becomes unfrozen/un-paused) starting from the frame image 82′, the previous frame of the frame image 82′, or the next frame of the frame image 82′, while the moving picture window 81 is continuously displayed on the display unit 80. That is, according to the search signal input by the user, the MPFS can be displayed on the display unit 80 in the MPFS window starting from the stopped frame 82′.

If a search cancel signal is input by the user when the moving picture window 81 and the MPFS window 82 are simultaneously displayed on the display unit 80 as shown in FIG. 4, the MPFS window 82 is not displayed anymore on the display unit 80 and the moving picture window 81 can be only displayed on the display unit 80. That is, the MPFS window 82 and the moving picture window 81 are replaced by a full-screen sized moving picture.

In FIGS. 2 through 6, the buttons are disposed on the digital image processing apparatus. However in other embodiments, the buttons can be displayed as soft buttons on the display unit 80 (e.g., a touch-screen).

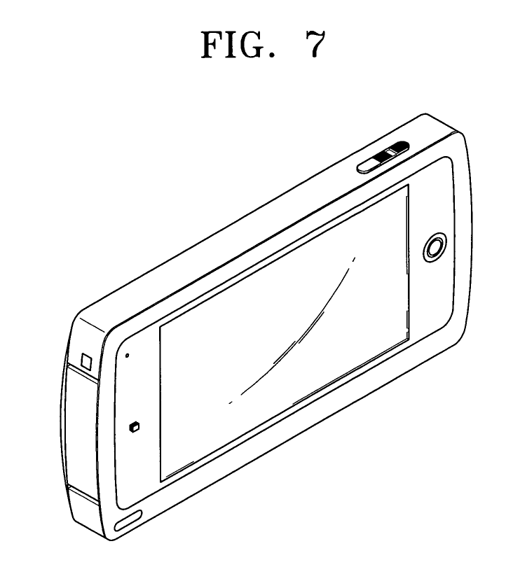

In the above description, a digital photographing apparatus is described as an example of a digital image processing apparatus, however, the present invention is not limited thereto. For example, the present invention can be applied to portable multimedia players (PMPs) as shown in FIG. 7, and PDAs, mobile phones, and computers that can display moving pictures from a moving picture file stored in the storage medium.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A digital image processing apparatus comprising:
a storage medium for storing moving picture files; and
a display unit for displaying a moving picture from a selected moving picture file in the storage medium, the display unit displaying, according to a search signal, the moving picture in a first window and displaying a moving picture for searching in a second window simultaneously and continuously with the moving picture in the first window, the moving picture for searching being a frame-skipping version of the moving picture.

2. The digital image processing apparatus of claim 1, wherein an initially-displayed frame of the moving picture for searching is a moving picture frame that was displayed at an instant the search signal was generated, a moving picture frame that is earlier than the moving picture frame that was displayed at an instant the search signal was generated, or a moving picture frame that is later than the moving picture frame that was displayed at an instant the search signal was generated.

3. The digital image processing apparatus of claim 1 further comprising an operation unit including at least one search button, the search signal being generated by a user pressing and holding the at least one search button.

4. The digital image processing apparatus of claim 3 wherein when the at least one search button is released to stop the search signal, the second window shows a frame image of the moving picture for searching that was displayed at an instant the search signal was stopped, a frame image earlier than the frame image of the moving picture for searching that was displayed at an instant the search signal was stopped, or a frame image later than the frame image of the moving picture for searching that was displayed at an instant the search signal was stopped.

5. The digital image processing apparatus of claim 4, wherein if a search cancel signal is input by the user, the second window showing the moving picture for searching and the first window showing the moving picture are replaced with a third window showing only the moving picture, the third window occupying substantially an entire display area of the display unit.

6. The digital image processing apparatus of claim 4, wherein if a display signal is input by the user after a search-stop signal, the second window showing the moving picture for searching and the first window showing the moving picture are replaced with a third window showing only a time-shifted version of moving picture, an initially-displayed frame of the time-shifted version being the frame image shown in the second window at an instant the display signal was generated, a frame image earlier than the frame image shown in the second window at an instant the display signal was generated, or a frame image later than the frame image shown in the second window at an instant the display signal was generated.

7. The digital image processing apparatus of claim 1 further comprising an operation unit including a search button and a search-stop button, the search signal being generated by a user pressing and releasing the search button, and the search signal being stopped by a user pressing and releasing the search-stop button.

8. The digital image processing apparatus of claim 7, wherein if the search-stop signal is generated, the second window shows a frame image of the moving picture for searching that was displayed at an instant the search signal was stopped, a frame image earlier than the frame image of the moving picture for searching that was displayed at an instant the search signal was stopped, a frame image later than the frame image of the moving picture for searching that was displayed at an instant the search signal was stopped.

9. The digital image processing apparatus of claim 8, wherein if a search cancel signal is input by the user, the second window showing the moving picture for searching and the first window showing the moving picture are replaced with a third window showing only the moving picture, the third window occupying substantially an entire display area of the display unit.

10. The digital image processing apparatus of claim 8, wherein if a display signal is input by the user after a search-stop signal relative to pressing and releasing the search-stop button, the second window showing the moving picture for searching and the first window showing the moving picture are replaced with a third window showing only a time-shifted version of moving picture, an initially-displayed frame of the time-shifted version being the frame image shown in the second window at an instant the display signal was generated, a frame image earlier than the frame image shown in the second window at an instant the display signal was generated, or a frame image later than the frame image shown in the second window at an instant the display signal was generated.

11. A method for searching a moving picture for a frame image, the method comprising:
retrieving moving picture frames from a moving picture file stored in a memory of a digital image processing apparatus;
processing the moving picture frames for playing the moving picture on a display unit of the digital image processing apparatus;
displaying the moving picture on substantially an entire display area of the display unit;
determining if a search signal has been received;
if the search signal has been received, resizing the moving picture for display in a first window of the display unit; and
displaying a moving picture for searching in a second window of the display unit, the moving picture for searching being a frame-skipping version of the moving picture.

12. The method of claim 11 wherein the first and second windows are adjacent to each other and different sizes.

13. The method of claim 12 wherein the second window is smaller than the first window.

14. The method of claim 11 wherein the step of displaying a moving picture for searching in a second window of the display unit comprises:
determining a frame image of the moving picture that was displayed at an instant that the search signal was received;
duplicating the frame image that was displayed at an instant that the search signal was received;
first displaying the frame image in the second window; and
after the first displaying step, second displaying non-adjacent frames in the second window.

15. The method of claim 11 further comprising:
determining if a search-stop signal is received; and
if the search-stop signal is received, pausing the moving picture for searching being shown in the second window.

16. The method of claim 11 further comprising:
determining if a display signal is received;
if the display signal is received, replacing the first and second windows with a substantially full-screen moving picture, an initially-displayed frame of the substantially full-screen moving picture being a frame image of the moving picture for searching shown in the second window that was displayed at an instant that the display signal was received.

17. The method of claim 11 further comprising:
determining if a search cancel signal is received;
if the search cancel signal is received, deleting the first and second windows; and
redisplaying the moving picture on substantially an entire display area of the display unit.
